(19) United States
(12) Patent Application Publication
(10) Pub. No.: US 2026/0352885 A1
(43) Pub. Date: Nov. 5, 2026

(54) TRANSFORM DOMAIN APPROACH TO INTRA PREDICTION

(71) Applicant: InterDigital CE Patent Holdings, SAS, Paris (FR)

(72) Inventors: Gagan Bihari RATH, Rennes (FR); Thierry DUMAS, Rennes (FR); Karam NASER, Mouaze (FR); Ya CHEN, Rennes (FR)

(21) Appl. No.: 19/159,521

(22) PCT Filed: Feb. 9, 2024
(86) PCT No.: PCT/EP2024/053292

§ 371 Date: Aug. 25, 2025

(30) Foreign Application Priority Data
Feb. 27, 2023 (EP) 23305258.8

(51) Int. Cl. H04N 19/61; H04N 19/105; H04N 19/176; H04N 19/18

(52) U.S. Cl. CPC H04N 19/61; H04N 19/105; H04N 19/176; H04N 19/18

(57) ABSTRACT

A method for decoding comprising: obtaining (110) video data representing a current block of samples of a picture; transforming (111) a causal area of samples neighboring the current block to obtain a first block of transform coefficients; obtaining (112) an information representing a number of largest transform coefficients to be kept in the first block of transform coefficients and performing an inverse transform of a second block corresponding to the kept transform coefficients to obtain a third block; deriving a predictor block from the third block; and, reconstructing (114) the current block by predicting said current block using the predictor block.

### 1. CROSS REFERENCE TO RELATED APPLICATIONS

This application claims priority to European Application No. 23305258.8, filed Feb. 27, 2023, which is incorporated herein by reference in its entirety.

### 2. TECHNICAL FIELD

At least one of the present embodiments generally relates to a method and a device for applying intra prediction in a picture.

### 3. BACKGROUND

To achieve high compression efficiency, video coding schemes usually employ predictions and transforms to leverage spatial and temporal redundancies in a video content. During an encoding, pictures of the video content are divided into blocks of samples (i.e., pixels), these blocks being then partitioned into one or more sub-blocks, called original sub-blocks in the following. An intra or inter prediction is then applied to each sub-block to exploit intra or inter image correlations. Whatever the prediction method used (intra or inter), a predictor sub-block is determined for each original sub-block. Then, a sub-block representing a difference between the original sub-block and the predictor sub-block, often denoted as a prediction error sub-block, or a prediction residual sub-block, or simply a residual sub-block, is transformed, quantized, and entropy coded to generate an encoded video stream. To reconstruct the video, the compressed data is decoded by inverse processes corresponding to the transform, quantization, and entropic coding.

A goal of intra prediction is to exploit the spatial correlation among neighboring pixels in a picture. Several intra prediction modes have been specified that aim to capture directionalities of object orientations and the slow changing intensity regions. In recent video compression standards, the intra prediction includes a plurality of intra prediction modes which consist of one DC, one PLANAR, and several angular prediction modes. The angular modes are designed to model directional structures of objects whereas the DC and the planar modes provide predictions for regions with slow and gradual intensity change. The directional modes can describe correctly object directionalities along a specified direction, but are insufficient to describe some common scenario such as periodic textures. In this context, in this disclosure, we propose a transform domain approach where a target block is predicted based on the transform coefficients of the causal neighbor blocks.

It is desirable to propose solutions allowing to overcome the above issue. In particular, it is desirable to have intra prediction modes correcting the insufficiencies of existing intra prediction modes, for instance, on periodic textures.

### 4. BRIEF SUMMARY

In a first aspect, one or more of the present embodiments provide a method for encoding comprising:
obtaining a current block of samples of a picture;
transforming a causal area of samples neighboring the current block to obtain a first block of transform coefficients;
obtaining a number of largest transform coefficients to be kept in the first block and performing an inverse transform of a second block corresponding to the kept transform coefficients to obtain a third block;
deriving a predictor block from the third block minimizing a difference between said predictor block and the current block; and,
predicting the current block using the predictor block corresponding to the obtained number of largest transform coefficients.

In a second aspect, one or more of the present embodiments provide a method for decoding comprising:
obtaining video data representing a current block of samples of a picture;
transforming a causal area of samples neighboring the current block to obtain a first block of transform coefficients;
obtaining an information representing a number of largest transform coefficients to be kept in the first block of transform coefficients and performing an inverse transform of a second block corresponding to the kept transform coefficients to obtain a third block;
deriving a predictor block from the third block; and,
reconstructing the current block by predicting said current block using the predictor block.

In an embodiment of the first or the second aspect the causal area of samples is L-shaped.

In an embodiment of the first or the second aspect the transform and the inverse transform use a DCT matrix adapted to a shape of the causal area of samples.

In an embodiment of the first or the second aspect the predictor block is a sub-part of the third block corresponding to a position of the current block.

In an embodiment of the first or the second aspect the second block of transform coefficients is generated by keeping in the first block of transform coefficients the largest transform coefficients covered by the number of largest transform coefficients of the first block of transform coefficients and by setting to zero the other transform coefficients of the first block of transform coefficients.

In an embodiment of the first or the second aspect samples of the predictor block are smoothed before prediction.

In an embodiment of the first or the second aspect the number of largest transform coefficients to be kept in the first block of transform coefficients is less than a maximum value.

In an embodiment of the first or the second aspect the number of largest transform coefficients to be kept in the first block of transform coefficients is a signaled value in a range of values or is a value derived in a range of values from information available when processing the current block or is a fixed value or is equal to the maximum value.

In a third aspect, one or more of the present embodiments provide a method comprising disabling an intra sub-partitions mode dividing an intra-predicted block vertically or horizontally in sub-partitions for a current block when the method for encoding or the method for decoding according to the first or the second aspect is enabled for the current block.

In a fourth aspect, one or more of the present embodiments provide a method comprising enabling an intra sub-partitions mode dividing an intra-predicted block vertically or horizontally in sub-partitions for a current block when the method for encoding or the method for decoding according to the first or the second aspect is enabled for the current block, and applying the method for encoding or the method for decoding according to the first or the second aspect to at least one sub-partition of the current block.

In a fifth aspect, one or more of the present embodiments provide a method comprising enabling the method for encoding or the method for decoding according to the first or the second aspect for blocks with size less than a maximum size or greater than a minimum size or less than a maximum size and greater than a minimum size.

In a sixth aspect, one or more of the present embodiments provide a method wherein an information signaled in a header, the header being a slice header or a picture parameter set or a sequence parameter set, indicates that all blocks of a coding entity referring to the header or all blocks meeting a constraint of a coding entity referring to the header can use the method for encoding or the method for decoding according to the first or the second aspect.

In a seventh aspect, one or more of the present embodiments provide a device for encoding comprising electronic circuitry configured for:
obtaining a current block of samples of a picture;
transforming a causal area of samples neighboring the current block to obtain a first block of transform coefficients;
obtaining a number of largest transform coefficients to be kept in the first block and performing an inverse transform of a second block corresponding to the kept transform coefficients to obtain a third block;
deriving a predictor block from the third block minimizing a difference between said predictor block and the current block; and,
predicting the current block using the predictor block corresponding to the obtained number of largest transform coefficients.

In a eightieth aspect, one or more of the present embodiments provide a device for decoding comprising electronic circuitry configured for:
obtaining video data representing a current block of samples of a picture;
transforming a causal area of samples neighboring the current block to obtain a first block of transform coefficients;
obtaining an information representing a number of largest transform coefficients to be kept in the first block of transform coefficients and performing an inverse transform of a second block corresponding to the kept transform coefficients to obtain a third block;
deriving a predictor block from the third block; and,
reconstructing the current block by predicting said current block using the predictor block.

In an embodiment of the seventh and eightieth aspect the causal area is L-shaped.

In an embodiment of the seventh and eightieth aspect the transform and the inverse transform use a DCT matrix adapted to a shape of the causal area of samples.

In an embodiment of the seventh and eightieth aspect the predictor block is a sub-part of the third block corresponding to a position of the current block.

In an embodiment of the seventh and eightieth aspect the second block of transform coefficients is generated by keeping in the first block of transform coefficients the largest transform coefficients covered by the number of largest transform coefficients of the first block of transform coefficients and by setting to zero the other transform coefficients of the first block of transform coefficients.

In an embodiment of the seventh and eightieth aspect samples of the predictor block are smoothed before prediction.

In an embodiment of the seventh and eightieth aspect the number of largest transform coefficients to be kept in the first block of transform coefficients is less than a maximum value.

In an embodiment of the seventh and eightieth aspect the number of largest transform coefficients to be kept in the first block of transform coefficients is a signaled value in a range of values or is a value derived in a range of values from information available when processing the current block or is a fixed value or is equal to the maximum value.

In a nineth aspect, one or more of the present embodiments provide a device comprising electronic circuitry configured for disabling an intra sub-partitions mode dividing an intra-predicted block vertically or horizontally in sub-partitions for a current block when a transform domain intra prediction mode is enabled for the current block.

In a tenth aspect, one or more of the present embodiments provide a device comprising electronic circuitry configured for enabling an intra sub-partitions mode dividing an intra-predicted block vertically or horizontally in sub-partitions for a current block when a transform domain intra prediction mode is enabled for the current block, and applying the transform domain intra prediction mode to at least one sub-partition of the current block.

In a eleventh aspect, one or more of the present embodiments provide a device comprising electronic circuitry configured for enabling a transform domain intra prediction mode for blocks with size less than a maximum size or greater than a minimum size or less than a maximum size and greater than a minimum size.

In a twelfth aspect, one or more of the present embodiments provide a device comprising electronic circuitry configured to signal an information in a header, the header being a slice header or a picture parameter set or a sequence parameter set, indicating that all blocks of a coding entity referring to the header or all blocks meeting a constraint of a coding entity referring to the header can use a transform domain intra prediction mode.

In a thirteenth aspect, one or more of the present embodiments provide a non-transitory information storage medium storing program code instructions for implementing the method according to the first or the second aspect.

In a fourteenth aspect, one or more of the present embodiments provide a computer program comprising program code instructions for implementing the method according to the first or the second aspect.

In a fifteenth aspect, one or more of the present embodiments provide a signal generated by the method for encoding according to the first aspect or by the device for encoding according to the seventh aspect.

### 5. BRIEF SUMMARY OF THE DRAWINGS

FIG. 1 illustrates schematically a context in which embodiments are implemented;

FIG. 2 illustrates schematically an example of partitioning undergone by a picture of pixels of an original video;

FIG. 3 depicts schematically a method for encoding a video stream;

FIG. 4 depicts schematically a method for decoding an encoded video stream;

FIG. 5A illustrates schematically an example of hardware architecture of a processing module able to implement an encoding module or a decoding module in which various aspects and embodiments are implemented;

FIG. 5B illustrates a block diagram of an example of a first system in which various aspects and embodiments are implemented;

FIG. 5C illustrates a block diagram of an example of a second system in which various aspects and embodiments are implemented;

FIG. 6 illustrates schematically reference samples for intra prediction when a CU is square (left) or rectangular (right);

FIG. 7 represents a L-shaped causal area according to various embodiments;

FIG. 8 illustrates schematically an embodiment of a method for predicting a block according to a transform domain based intra prediction mode;

FIG. 9 illustrates a method for applying a DCT transform to an L-shaped causal area neighboring a block;

FIG. 10 illustrates a detail of the method for predicting a block according to a transform domain based intra prediction mode;

FIG. 11 illustrates schematically an embodiment of a method for reconstructing a block encoded according to the transform domain based intra prediction mode; and,

FIG. 12A to 12F illustrates various example of causal areas.

### 6. DETAILED DESCRIPTION

The following examples of embodiments are described in the context of a video format similar to VVC (Versatile Video Coding (VVC) developed by a joint collaborative team of ITU-T and ISO/IEC experts known as the Joint Video Experts Team (JVET)). However, these embodiments are not limited to the video coding/decoding method corresponding to VVC. These embodiments are in particular adapted to various video formats comprising (and derived from) for example HEVC (ISO/IEC 23008-2-MPEG-H Part 2, High Efficiency Video Coding/ITU-T H.265)), AVC ((ISO/CEI 14496-10), EVC (Essential Video Coding/MPEG-5), AV1, AV2 and VP9. In addition, these embodiments are also adapted to various still picture formats such as JPEG.

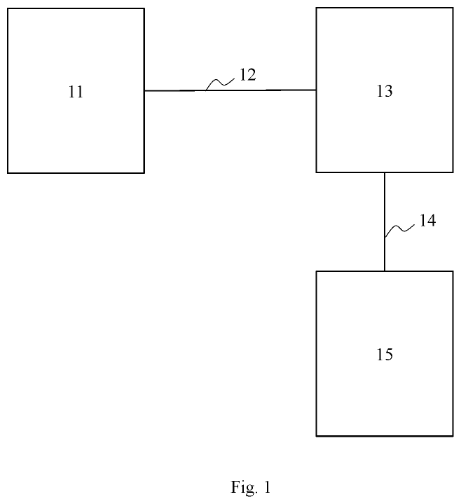

FIG. 1 illustrates schematically a context in which embodiments are implemented.

In FIG. 1, a system 11, that could be a camera, a storage device, a computer, a server or any device capable of delivering a video stream (i.e., video data), transmits a video stream to a system 13 using a communication channel 12. The video stream is either encoded and transmitted by the system 11 or received and/or stored by the system 11 and then transmitted. The communication channel 12 is a wired (for example Internet or Ethernet) or a wireless (for example WiFi, 3G, 4G or 5G) network link.

The system 13, that could be for example a set top box, receives and decodes the video stream to generate a sequence of decoded pictures. A post processing may be applied to the decoded pictures.

The obtained sequence of decoded pictures is then transmitted to a display system 15 using a communication channel 14, that could be a wired or wireless network. The display system 15 then displays said pictures.

In an embodiment, the system 13 is comprised in the display system 15. In that case, the system 13 and display system 15 are comprised in a TV, a computer, a tablet, a smartphone, a head-mounted display, etc.

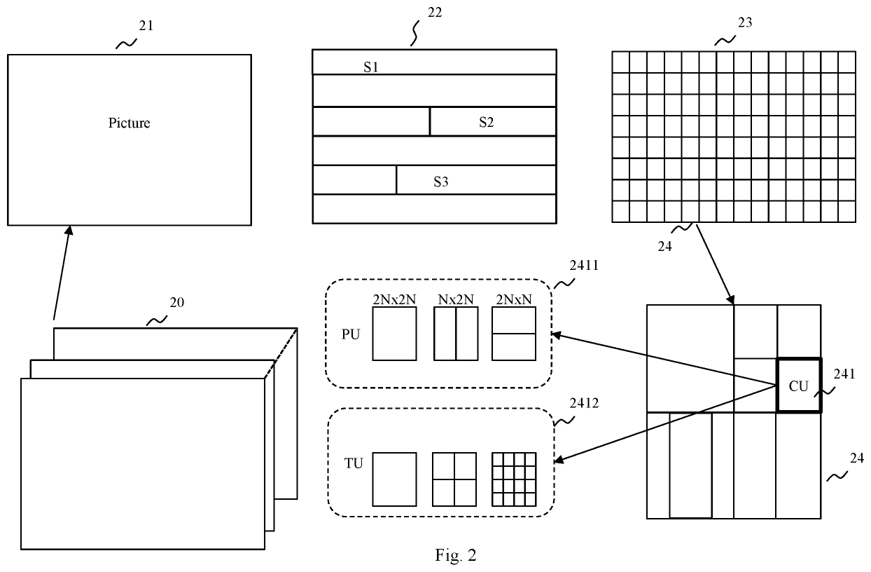

FIGS. 2, 3 and 4 introduce an example of video format.

FIG. 2 illustrates an example of partitioning undergone by a picture of pixels 21 of an original video sequence 20. It is considered here that a pixel is composed of three components: a luminance component and two chrominance components. Other types of pixels are however possible comprising less or more components such as only a luminance component or an additional depth component or transparency component.

A picture is divided into a plurality of coding entities. First, as represented by reference 23 in FIG. 2, a picture is divided in a grid of blocks called coding tree units (CTU). A CTU consists of an N×N block of luminance samples together with two corresponding blocks of chrominance samples. N is generally a power of two having a maximum value of “128” for example. Second, a picture is divided into one or more groups of CTU. For example, it can be divided into one or more tile rows and tile columns, a tile being a sequence of CTUs covering a rectangular region of a picture. In some cases, a tile could be divided into one or more bricks, each of which consisting of at least one row of CTUs within the tile. Above the concept of tiles and bricks, another encoding entity, called slice, exists, that can contain at least one tile of a picture or at least one brick of a tile.

In the example of FIG. 2, as represented by reference 22, the picture 21 is divided into three slices S1, S2 and S3 of the raster-scan slice mode, each comprising a plurality of tiles (not represented), each tile comprising only one brick.

As represented by reference 24 in FIG. 2, a CTU may be partitioned into the form of a hierarchical tree of one or more sub-blocks called coding units (CU). The CTU is the root (i.e. the parent node) of the hierarchical tree and can be partitioned in a plurality of CUs (i.e. child nodes). Each CU becomes a leaf of the hierarchical tree if it is not further partitioned in smaller CUs, or becomes a parent node of smaller CUs (i.e. child nodes) if it is further partitioned.

In the example of FIG. 2, the CTU 24 is first partitioned in “4” square CUs using a quadtree type partitioning. The upper left CU is a leaf of the hierarchical tree since it is not further partitioned, i.e., it is not a parent node of any other CU. The upper right CU is further partitioned in “4” smaller square CUs using again a quadtree type partitioning. The bottom right CU is vertically partitioned in “2” rectangular CUs using a binary tree type partitioning. The bottom left CU is vertically partitioned in “3” rectangular CUs using a ternary tree type partitioning.

During the coding of a picture, the partitioning is adaptive, each CTU being partitioned so as to optimize a compression efficiency of the CTU criterion.

In HEVC the concept of prediction unit (PU) and transform unit (TU) were also introduced. Indeed, in HEVC, the coding entities that are used for prediction (i.e., a PU) and transform (i.e. a TU) can be different subdivisions of a CU. For example, as represented in FIG. 2, a CU of size 2N×2N, can be divided in PUs 2411 of size N×2N or of size 2N×N. In addition, said CU can be divided in “4” TUs 2412 of size N×N or in “16” TUs of size (N/2)×(N/2). The TUs are always of square shapes.

One can note that in VVC, except in some particular cases, boundaries of the TU and PU are aligned on those of the CU. Consequently, a CU comprises generally one TU and one PU.

In the present application, the term “block” or “picture block” can be used to refer to any one of a CTU, a CU, a PU and a TU. In addition, the term “block” or “picture block” can be used to refer to a macroblock, a partition and a sub-block as specified in H.264/AVC or in other video coding standards, and more generally to refer to an array of samples of numerous sizes.

In the present application, the terms “reconstructed” and “decoded” may be used interchangeably, the terms “pixel” and “sample” may be used interchangeably, the terms “image,” “picture”, “sub-picture”, “slice” and “frame” may be used interchangeably. Usually, but not necessarily, the term “reconstructed” is used at the encoder side while “decoded” is used at the decoder side.

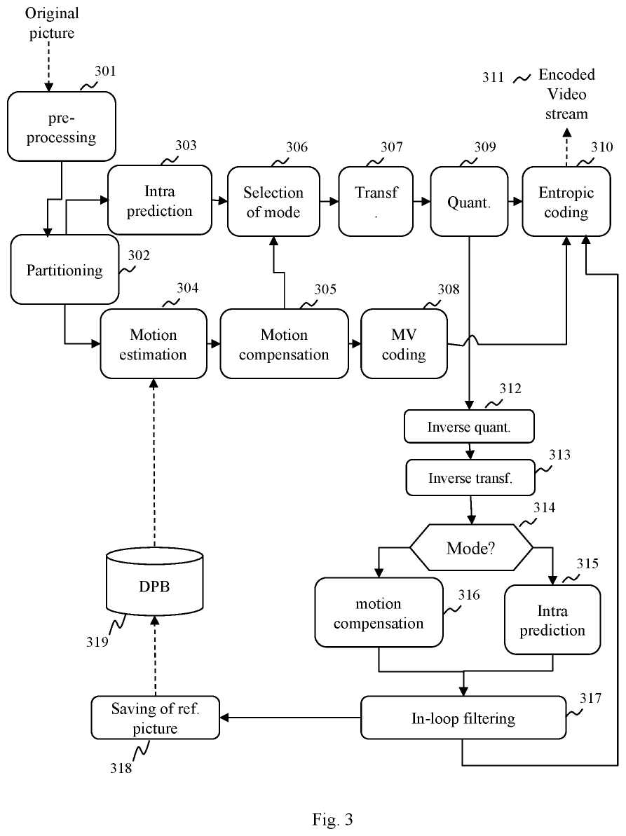

FIG. 3 depicts schematically a method for encoding a video stream executed by an encoding module. For instance, the method for encoding of FIG. 3 is executed by the system 11. Variations of this method for encoding are contemplated, but the method for encoding of FIG. 3 is described below for purposes of clarity without describing all expected variations.

Before being encoded, a current original picture of an original video sequence may go through a pre-processing. For example, in a step 301, a color transform is applied to the current original picture (e.g., conversion from RGB 4:4:4 to YCbCr 4:2:0), or a remapping is applied to the current original picture components in order to get a signal distribution more resilient to compression (for instance using a histogram equalization of one of the color components). Pictures obtained by pre-processing are called pre-processed pictures in the following.

The encoding of a pre-processed picture begins with a partitioning of the pre-processed picture during a step 302, as described in relation to FIG. 2. The pre-processed picture is thus partitioned into CTU, CU, PU, TU, etc.

For each block, the encoding module determines then a coding mode between an intra prediction mode and an inter prediction mode.

Intra prediction aims at exploiting spatial redundancies in a picture. In a step 303, a current block (i.e. a PU or CU) is spatially predicted from samples of causal neighbour blocks in the same picture, i.e., the blocks on the top and top-right, the blocks on the left and left-bottom, and the top-left block. The encoder constructs a plurality of predictor blocks for the current block from these samples and chooses the one that leads to the best rate-distortion (RD) performance. In recent video compression methods, up to “67” intra prediction modes leading to “67” predictor blocks are constructed. The plurality of predictor blocks comprises a planar mode (indexed as mode 0), a DC mode (indexed as mode “1”) and the remaining “65” are angular modes. The planar and DC modes aim to model slow changing intensity regions whereas the angular modes are designed to model directional structures present in pictures. The best prediction mode is encoded and transmitted to the decoder so that the decoder constructs the same intra predictor block for the current block. Further improvements to intra prediction has been proposed recently that aim at improving the intra prediction accuracy through decoder side intra mode derivation (DIMD) and fusion for template-based intra mode derivation (TIMD).

To keep the decoder complexity low, the intra prediction uses generally only one row of reference pixels on top and one column of reference pixels on left of the current block. Though the encoder has the option of choosing among three sets of reference lines in a mode called multiple reference lines (MRL), the prediction is always based on one reference line that consists of one row on top and one column on left. Because of this limitation, the amount of information contained in the reference pixels is quite limited and thus the intra prediction efficiency, which is based on the correlation between the current block's pixels and the reference pixels, is also limited. More recently, a proposal for using up to two adjacent reference lines has been adopted. In this case, the predictor is constructed as a weighted average of the two predictors each based on a single reference line.

In an example, intra prediction can be represented with a process comprising three steps: reference sample generation; intra sample prediction; and post-processing of predicted samples.

### Reference Sample Generation:

For a current CU of size M×N, a top reference array consists of (2N+1) decoded samples from the decoded top CU and top-right CU. Similarly, a left reference array consists of (2M+1) samples from the decoded CUs on the left and below-left. If some of the samples on top or left are not available, because of the corresponding CUs not being in the same slice, or the current CU being at a frame boundary, etc., then a method called reference sample substitution is performed, where the missing samples are copied from the available samples in a clock-wise direction. Then, depending on the current CU size and the prediction mode, the reference samples are filtered using the [¼, ½, ¼] filter.

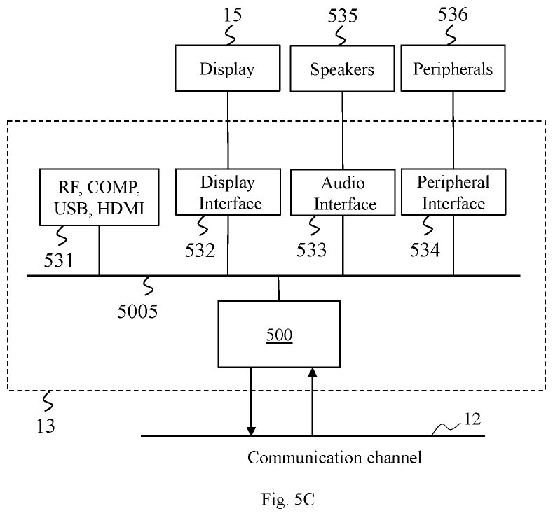

FIG. 6 illustrates schematically reference samples for intra prediction when the CU is square (left) or rectangular (right).

### Intra Sample Prediction:

In the intra sample prediction step, the encoder checks for the best prediction mode among the “67” prediction modes. As already mentioned, the PLANAR and DC prediction modes are used to predict smooth and gradually changing regions, whereas angular prediction modes are used to capture different directional structures. The directional prediction modes define predictions along, for example, “65” directions in the range from “45” degrees to “−135” degrees in clock-wise fashion. In the DC prediction mode, either the average value of the reference samples on top and left, or the average value of the reference samples on the longer side of the block, is used as a prediction for the entire block. In the planar prediction mode, the predicted values are computed as the average of a horizontal interpolation and a vertical interpolation; the former is a linear interpolation between the left reference samples and the top-right reference sample whereas the latter is another linear interpolation between the top reference samples and the bottom-left reference sample. In the directional modes, the prediction is obtained by copying the reference samples along the associated directions. Depending on the current block size and the prediction direction, the reference samples may be filtered for a Gaussian or a cubic interpolation.

### Post-Processing of Predicted Samples:

In the post-processing step, the predicted values may be smoothed in order to avoid discontinuities for certain prediction modes, such as the PLANAR mode, the DC mode, the purely vertical and purely horizontal modes, and the modes with directions from bottom-left towards top-right or vice versa. The smoothing is performed with a technique called position dependent intra prediction combination (PDPC). Decoder side Intra Mode Derivation (DIMD) is a new tool to derive the intra mode for coding a current CU. When DIMD is applied, two intra prediction modes among the “65” directional modes, that are likely the two best intra prediction modes for predicting the current CU, are derived from a Histogram of Oriented Gradients (HOG) computed from the neighbouring samples of the current block. The predictions with these two modes are combined with the planar mode predictor with weights derived from the histogram. As the prediction modes are derived using the neighbouring decoded samples, but not the current block information, the decoder can derive the same two best prediction modes as the encoder and can compute the prediction as a weighted sum with the planar mode predictor. For each intra-coded block, a flag namely dimd_flag indicating whether a DIMD mode is to be applied or not is signalled.

An intra prediction mode used to code a current CU derived using a Fusion for Template-based Intra Mode Derivation (TIMD) was newly introduced. For each intra prediction mode in a most probable modes (MPMs) list, the Sum of Absolute Transformed Differences (SATD) between the prediction and reconstruction samples of a template is calculated. The prediction of the template is obtained for each intra prediction mode from the reference samples of the template. First two intra prediction modes with the minimum SATD are selected. After retaining two intra prediction modes from the first pass, for each of these two modes, if the mode is directional, its two closest extended directional prediction modes are tested in terms of SATD. The extended directional modes are inserted half-way between two adjacent directional modes; thus, the total number of directional intra prediction modes is extended from “65” to “129”. The two intra prediction modes are fused with weights after applying the PDPC process to arrive at the final prediction. For each intra-coded block, a flag namely timd_flag indicating whether a TIMD mode is to be applied or not is signalled.

Another newly introduced intra prediction mode is Intra template matching prediction (Intra TMP). Intra TMP is a special intra prediction mode in which a best predictor block from the reconstructed part of the current picture whose L-shaped template matches the best with the template of the current block is identified. Then, the encoder uses the identified block corresponding to the most similar template as a predictor block. The encoder then signals the usage of this mode, and the same prediction operation is performed at the decoder side. The Intra TMP mode is signalled at CU level through a dedicated flag when DIMD is not used for the current CU.

The inter prediction consists in predicting the pixels of a current block from a block of pixels, referred to as the reference block, of a picture preceding or following the current picture, this picture being referred to as the reference picture. During the coding of a current block in accordance with the inter prediction method, a block of the reference picture closest, in accordance with a similarity criterion, to the current block is determined by a motion estimation step 304. During step 304, a motion vector indicating the position of the reference block in the reference picture is determined. Said motion vector is used during a motion compensation step 305 during which a residual block is calculated in the form of a difference between the current block and the reference block. In first video compression standards, the mono-directional inter prediction mode described above was the only inter mode available. As video compression standards evolve, the family of inter modes has grown significantly and comprises now many different inter modes.

During a selection step 306, the prediction mode optimising the compression performances, in accordance with a rate/distortion optimization criterion (i.e. RDO criterion), among the prediction modes tested (Intra prediction modes, Inter prediction modes), is selected by the encoding module.

When the prediction mode is selected, the residual block is transformed during a step 307. The transformed block is then quantized during a step 309.

Note that the encoding module can skip the transform and apply quantization directly to the non-transformed residual signal. When the current block is coded according to an intra prediction mode, information indicating the selected intra prediction mode are encoded by an entropy encoder during a step 310. When the current block is encoded according to an inter prediction, when appropriate, a motion vector of the block is predicted from a prediction vector selected from a set of motion vector predictors derived from reconstructed blocks situated in a spatial and temporal vicinity of the block to be encoded. The motion information is next encoded by the entropy encoder during step 310 in the form of a motion residual and an index for identifying the prediction vector. The transformed and quantized residual block is encoded by the entropy encoder during step 310.

Note that the encoding module can bypass both transform and quantization, i.e., the entropy encoding is applied on the residual without the application of the transform or quantization processes. The result of the entropy encoding is inserted in an encoded video stream (i.e. in video data) 311.

Metadata such as SEI (supplemental enhancement information) messages can be attached to the encoded video stream 311. A SEI message as defined for example in standards such as AVC, HEVC or VVC (or in standard Versatile supplemental enhancement information (VSEI) messages for coded video bitstreams-H.274) is a data container or a syntax structure associated to a video stream and comprising metadata providing information relative to the video stream.

After the quantization step 309, the current block is reconstructed so that the pixels corresponding to that block can be used for future predictions. This reconstruction phase is also referred to as a prediction loop. An inverse quantization is therefore applied to the transformed and quantized residual block during a step 312 and an inverse transformation is applied during a step 313. According to the prediction mode used for the block obtained during a step 314, the predictor block of the block is reconstructed. If the current block is encoded according to an inter prediction mode, the encoding module applies, when appropriate, during a step 316, a motion compensation using the motion vector of the current block in order to identify the reference block of the current block. If the current block is encoded according to an intra prediction mode, during a step 315, the intra prediction mode selected for the current block is used for reconstructing the predictor block of the current block. The predictor block and the reconstructed residual block are added in order to obtain the reconstructed current block.

Following the reconstruction, an in-loop filtering intended to reduce the encoding artefacts is applied, during a step 317, to the reconstructed block. This filtering is called in-loop filtering since this filtering occurs in the prediction loop to obtain at the decoder the same reference pictures as the encoder and thus avoid a drift between the encoding and the decoding processes. In-loop filtering tools comprises deblocking filtering, SAO (Sample adaptive Offset) and ALF (Adaptive Loop Filtering).

When a block is reconstructed, it is inserted during a step 318 into a reconstructed picture stored in a memory 319 of reconstructed pictures generally called Decoded Picture Buffer (DPB). The reconstructed pictures thus stored can then serve as reference pictures for other pictures to be coded.

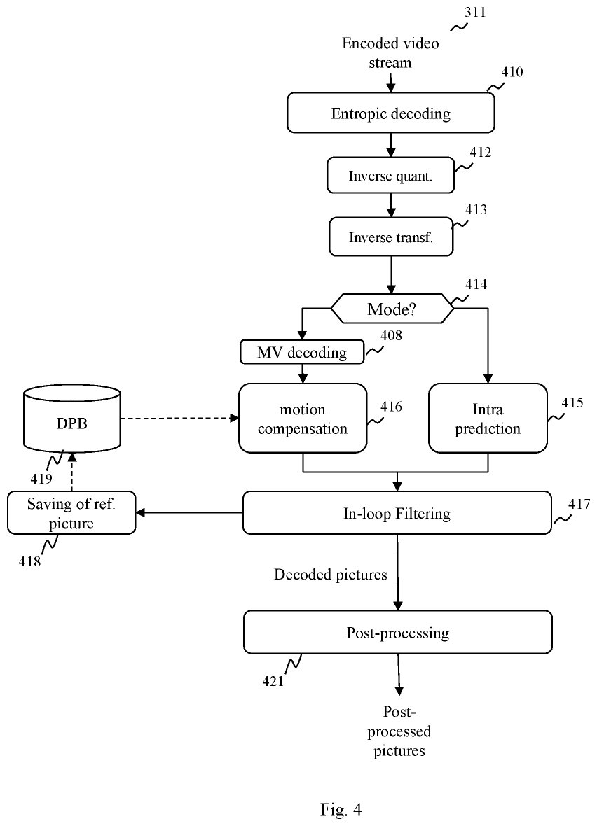

FIG. 4 depicts schematically a method for decoding the encoded video stream (i.e. the video data) 311 encoded according to method described in relation to FIG. 3 executed by a decoding module. For instance, the method for decoding of FIG. 4 is executed by the system 13. Variations of this method for decoding are contemplated, but the method for decoding of FIG. 4 is described below for purposes of clarity without describing all expected variations.

The decoding is done block by block. For a current block, it starts with an entropic decoding of the current block during a step 410. Entropic decoding allows to obtain, at least, the prediction mode of the block.

If the block has been encoded according to an inter prediction mode, the entropy decoding allows to obtain, when appropriate, a motion vector predictor index, a motion residual and a prediction residual block. During a step 408, a motion vector is reconstructed for the current block using the prediction vector index and the motion residual.

If the block has been encoded according to an intra prediction mode, entropy decoding allows, when appropriate, to obtain a prediction mode and a prediction residual block. Steps 412, 413, 414, 415, 416 and 417 implemented by the decoding module are in all respects identical respectively to steps 312, 313, 314, 315, 316 and 317 implemented by the encoding module.

Decoded blocks are saved in decoded pictures and the decoded pictures are stored in a DPB 419 in a step 418. When the decoding module decodes a given picture, the pictures stored in the DPB 419 are identical to the pictures stored in the DPB 319 by the encoding module during the encoding of said given picture. The decoded picture can also be sent as output by the decoding module for instance to be displayed.

Following the in-loop filtering (i.e., following the generation of the decoded pictures), a post-processing step 421 may be applied.

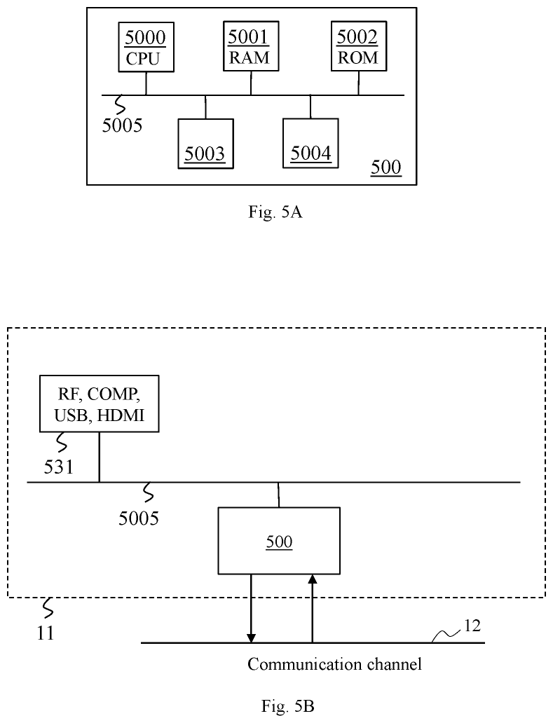

FIGS. 5A, 5B and 5C describes examples of device, apparatus and/or system allowing implementing the various embodiments.

FIG. 5A illustrates schematically an example of hardware architecture of a processing module 500 able to implement an encoding module or a decoding module capable of implementing respectively a method for encoding of FIG. 3 and a method for decoding of FIG. 4 modified according to different aspects and embodiments. The encoding module is for example comprised in the system 11 when this system is in charge of encoding the video stream. The decoding module is for example comprised in the system 13.

The processing module 500 comprises, connected by a communication bus 5005: a processor or CPU (central processing unit) 5000 encompassing one or more microprocessors, general purpose computers, special purpose computers, and processors based on a multi-core architecture, as non-limiting examples; a random access memory (RAM) 5001; a read only memory (ROM) 5002; a storage unit 5003, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive, or a storage medium reader, such as a SD (secure digital) card reader and/or a hard disc drive (HDD) and/or a network accessible storage device; at least one communication interface 5004 for exchanging data with other modules, devices or system. The communication interface 5004 can include, but is not limited to, a transceiver configured to transmit and to receive data over a communication channel. The communication interface 5004 can include, but is not limited to, a modem or network card.

If the processing module 500 implements a decoding module, the communication interface 5004 enables for instance the processing module 500 to receive encoded video streams and to provide a sequence of decoded pictures. If the processing module 500 implements an encoding module, the communication interface 5004 enables for instance the processing module 500 to receive a sequence of original picture data to encode and to provide an encoded video stream.

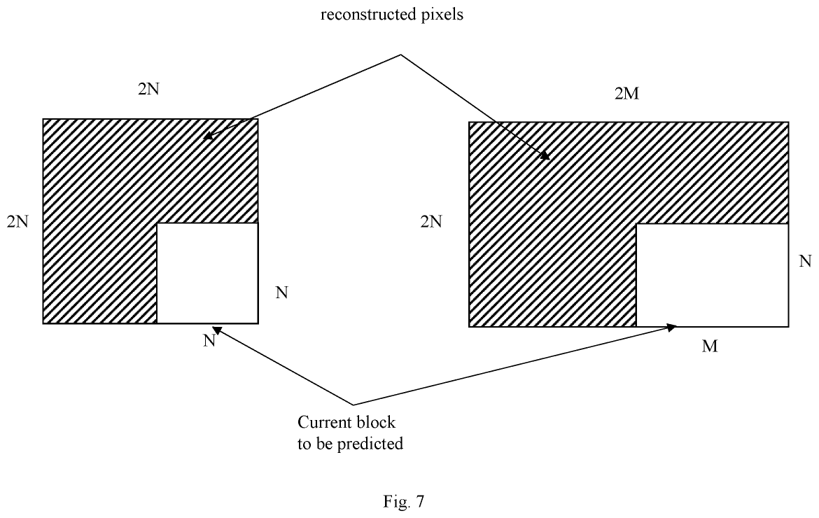

The processor 5000 is capable of executing instructions loaded into the RAM 5001 from the ROM 5002, from an external memory (not shown), from a storage medium, or from a communication network. When the processing module 500 is powered up, the processor 5000 is capable of reading instructions from the RAM 5001 and executing them. These instructions form a computer program causing, for example, the implementation by the processor 5000 of a decoding method as described in relation with FIG. 4 and/or an encoding method described in relation to FIG. 3, and methods illustrated in relation to FIGS. 8 to 11, these methods comprising various aspects and embodiments described below in this document.

All or some of the algorithms and steps of the methods of FIGS. 3, 4 and 8-11 may be implemented in software form by the execution of a set of instructions by a programmable machine such as a DSP (digital signal processor) or a microcontroller, or be implemented in hardware form by a machine or a dedicated component such as a FPGA (field-programmable gate array) or an ASIC (application-specific integrated circuit).

As can be seen, microprocessors, general purpose computers, special purpose computers, processors based or not on a multi-core architecture, DSP, microcontroller, FPGA and ASIC are electronic circuitry adapted or configured to implement at least partially the methods of FIGS. 3, 4, 8-11.

FIG. 5C illustrates a block diagram of an example of the system 13 in which various aspects and embodiments are implemented. The system 13 can be embodied as a device including the various components described below and is configured to perform one or more of the aspects and embodiments described in this document. Examples of such devices include, but are not limited to, various electronic devices such as personal computers, laptop computers, smartphones, tablet computers, digital multimedia set top boxes, digital television receivers, personal video recording systems, connected home appliances and head mounted display. Elements of system 13, singly or in combination, can be embodied in a single integrated circuit (IC), multiple ICs, and/or discrete components. For example, in at least one embodiment, the system 13 comprises one processing module 500 that implements a decoding module. In various embodiments, the system 13 is communicatively coupled to one or more other systems, or other electronic devices, via, for example, a communications bus or through dedicated input and/or output ports. In various embodiments, the system 13 is configured to implement one or more of the aspects described in this document.

The input to the processing module 500 can be provided through various input modules as indicated in block 531. Such input modules include, but are not limited to, (i) a radio frequency (RF) module that receives an RF signal transmitted, for example, over the air by a broadcaster, (ii) a component (COMP) input module (or a set of COMP input modules), (iii) a Universal Serial Bus (USB) input module, and/or (iv) a High Definition Multimedia Interface (HDMI) input module. Other examples, not shown in FIG. 5C, include composite video.

In various embodiments, the input modules of block 531 have associated respective input processing elements as known in the art. For example, the RF module can be associated with elements suitable for (i) selecting a desired frequency (also referred to as selecting a signal, or band-limiting a signal to a band of frequencies), (ii) down-converting the selected signal, (iii) band-limiting again to a narrower band of frequencies to select (for example) a signal frequency band which can be referred to as a channel in certain embodiments, (iv) demodulating the down-converted and band-limited signal, (v) performing error correction, and (vi) demultiplexing to select the desired stream of data packets. The RF module of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, down-converting the received signal to a lower frequency (for example, an intermediate frequency or a near-baseband frequency) or to baseband. In one set-top box embodiment, the RF module and its associated input processing element receives an RF signal transmitted over a wired (for example, cable) medium, and performs frequency selection by filtering, down-converting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF module includes an antenna.

Additionally, the USB and/or HDMI modules can include respective interface processors for connecting system 13 to other electronic devices across USB and/or HDMI connections. It is to be understood that various aspects of input processing, for example, Reed-Solomon error correction, can be implemented, for example, within a separate input processing IC or within the processing module 500 as necessary. Similarly, aspects of USB or HDMI interface processing can be implemented within separate interface ICs or within the processing module 500 as necessary. The demodulated, error corrected, and demultiplexed stream is provided to the processing module 500.

Various elements of system 13 can be provided within an integrated housing. Within the integrated housing, the various elements can be interconnected and transmit data therebetween using suitable connection arrangements, for example, an internal bus as known in the art, including the Inter-IC (I2C) bus, wiring, and printed circuit boards. For example, in the system 13, the processing module 500 is interconnected to other elements of said system 13 by the bus 5005.

The communication interface 5004 of the processing module 500 allows the system 13 to communicate on the communication channel 12. As already mentioned above, the communication channel 12 can be implemented, for example, within a wired and/or a wireless medium.

Data is streamed, or otherwise provided, to the system 13, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 13 using the RF connection of the input block 531. As indicated above, various embodiments provide data in a non-streaming manner. Additionally, various embodiments use wireless networks other than Wi-Fi, for example a cellular network or a Bluetooth network.

The system 13 can provide an output signal to various output devices, including the display system 15, speakers 535, and other peripheral devices 536. The display system 15 of various embodiments includes one or more of, for example, a touchscreen display, an organic light-emitting diode (OLED) display, a curved display, and/or a foldable display. The display system 15 can be for a television, a tablet, a laptop, a cell phone (mobile phone), a head mounted display or other devices. The display system 15 can also be integrated with other components (for example, as in a smart phone), or separate (for example, an external monitor for a laptop). The other peripheral devices 536 include, in various examples of embodiments, one or more of a stand-alone digital video disc (or digital versatile disc) (DVR, for both terms), a disk player, a stereo system, and/or a lighting system. Various embodiments use one or more peripheral devices 536 that provide a function based on the output of the system 13. For example, a disk player performs the function of playing an output of the system 13.

In various embodiments, control signals are communicated between the system 13 and the display system 15, speakers 535, or other peripheral devices 536 using signaling such as AV.Link, Consumer Electronics Control (CEC), or other communications protocols that enable device-to-device control with or without user intervention. The output devices can be communicatively coupled to system 13 via dedicated connections through respective interfaces 532, 533, and 534. Alternatively, the output devices can be connected to system 13 using the communications channel 12 via the communications interface 5004 or a dedicated communication channel corresponding to the communication channel 12 in FIG. 5C via the communication interface 5004. The display system 15 and speakers 535 can be integrated in a single unit with the other components of system 13 in an electronic device such as, for example, a television. In various embodiments, the display interface 532 includes a display driver, such as, for example, a timing controller (T Con) chip.

The display system 15 and speaker 535 can alternatively be separate from one or more of the other components. In various embodiments in which the display system 15 and speakers 535 are external components, the output signal can be provided via dedicated output connections, including, for example, HDMI ports, USB ports, or COMP outputs.

FIG. 5B illustrates a block diagram of an example of the system 11 in which various aspects and embodiments are implemented. System 11 is very similar to system 13. The system 11 can be embodied as a device including the various components described below and is configured to perform one or more of the aspects and embodiments described in this document. Examples of such devices include, but are not limited to, various electronic devices such as personal computers, laptop computers, smartphones, tablet computers, a camera and a server. Elements of system 11, singly or in combination, can be embodied in a single integrated circuit (IC), multiple ICs, and/or discrete components. For example, in at least one embodiment, the system 11 comprises one processing module 500 that implements an encoding module. In various embodiments, the system 11 is communicatively coupled to one or more other systems, or other electronic devices, via, for example, a communications bus or through dedicated input and/or output ports. In various embodiments, the system 11 is configured to implement one or more of the aspects described in this document.

The input to the processing module 500 can be provided through various input modules as indicated in block 531 already described in relation to FIG. 5C.

Various elements of system 11 can be provided within an integrated housing. Within the integrated housing, the various elements can be interconnected and transmit data therebetween using suitable connection arrangements, for example, an internal bus as known in the art, including the Inter-IC (12C) bus, wiring, and printed circuit boards. For example, in the system 11, the processing module 500 is interconnected to other elements of said system 11 by the bus 5005.

The communication interface 5004 of the processing module 500 allows the system 11 to communicate on the communication channel 12.

Data is streamed, or otherwise provided, to the system 11, in various embodiments, using a wireless network such as a Wi-Fi network, for example IEEE 802.11 (IEEE refers to the Institute of Electrical and Electronics Engineers). The Wi-Fi signal of these embodiments is received over the communications channel 12 and the communications interface 5004 which are adapted for Wi-Fi communications. The communications channel 12 of these embodiments is typically connected to an access point or router that provides access to external networks including the Internet for allowing streaming applications and other over-the-top communications. Other embodiments provide streamed data to the system 11 using the RF connection of the input block 531.

As indicated above, various embodiments provide data in a non-streaming manner. Additionally, various embodiments use wireless networks other than Wi-Fi, for example a cellular network or a Bluetooth network.

The data provided to the system 11 can be provided in different format. In various embodiments these data are encoded and compliant with a known video compression format such as AV1, VP9, VVC, HEVC, AVC, etc. In various embodiments, these data are raw data provided for example by a picture and/or audio acquisition module connected to the system 11 or comprised in the system 11. In that case, the processing module 500 take in charge the encoding of these data.

The system 11 can provide an output signal to various output devices capable of storing and/or decoding the output signal such as the system 13.

Various implementations involve decoding. “Decoding”, as used in this application, can encompass all or part of the processes performed, for example, on a received encoded video stream in order to produce a final output suitable for display. In various embodiments, such processes include one or more of the processes typically performed by a decoder, for example, entropy decoding, inverse quantization, inverse transformation, and prediction. In various embodiments, such processes also, or alternatively, include processes performed by a decoder of various implementations described in this application, for example, for applying a transform domain based intra prediction mode according to an embodiment of this application.

Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application can encompass all or part of the processes performed, for example, on an input video sequence in order to produce an encoded video stream. In various embodiments, such processes include one or more of the processes typically performed by an encoder, for example, partitioning, prediction, transformation, quantization, and entropy encoding. In various embodiments, such processes also, or alternatively, include processes performed by an encoder of various implementations described in this application, for example, for applying a transform domain based intra prediction mode according to an embodiment of this application.

Whether the phrase “encoding process” is intended to refer specifically to a subset of operations or generally to the broader encoding process will be clear based on the context of the specific descriptions and is believed to be well understood by those skilled in the art.

Note that the syntax elements names as used herein, are descriptive terms. As such, they do not preclude the use of other syntax element names.

When a figure is presented as a flow diagram, it should be understood that it also provides a block diagram of a corresponding apparatus. Similarly, when a figure is presented as a block diagram, it should be understood that it also provides a flow diagram of a corresponding method/process.

Various embodiments refer to rate distortion optimization. In particular, during the encoding process, the balance or trade-off between a rate and a distortion is usually considered. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of a reconstructed signal after coding and decoding. Faster approaches may also be used, to save encoding complexity, in particular with computation of an approximated distortion based on a prediction or a prediction residual signal, not the reconstructed one. Mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented, for example, in a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, retrieving the information from memory or obtaining the information for example from another device, module or from user.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, “one or more of” for example, in the cases of “A/B”, “A and/or B” and “at least one of A and B”, “one or more of A and B” is intended to encompass the selection of the first listed option (A) only, or the selection of the second listed option (B) only, or the selection of both options (A and B). As a further example, in the cases of “A, B, and/or C” and “at least one of A, B, and C”, “one or more of A, B and C” such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

Also, as used herein, the word “signal” refers to, among other things, indicating something to a corresponding decoder. For example, in certain embodiments the encoder signals a use of some coding tools. In this way, in an embodiment the same parameters can be used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

As will be evident to one of ordinary skill in the art, implementations can produce a variety of signals formatted to carry information that can be, for example, stored or transmitted. The information can include, for example, instructions for performing a method, or data produced by one of the described implementations. For example, a signal can include a signal indicating a selected intra prediction mode. Such a signal can be formatted, for example, as an electromagnetic wave (for example, using a radio frequency portion of spectrum) or as a baseband signal. The formatting can include, for example, encoding an encoded video stream and modulating a carrier with the encoded video stream. The information that the signal carries can be, for example, analog or digital information. The signal can be transmitted over a variety of different wired or wireless links, as is known. The signal can be stored on a processor-readable medium.

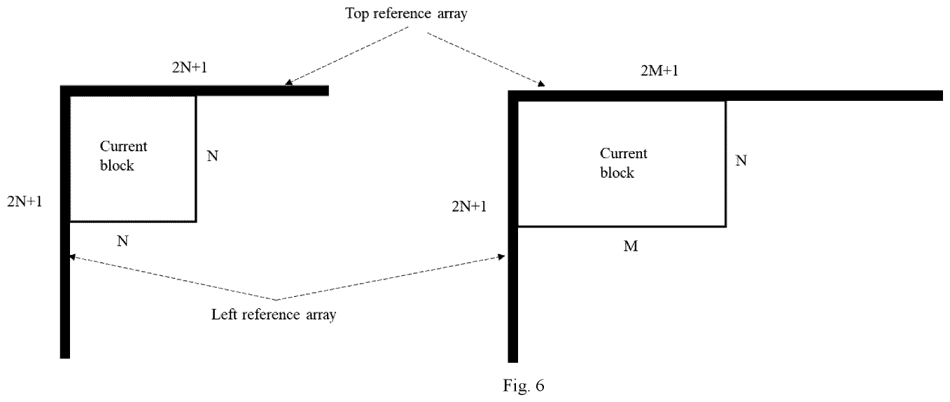

In the following embodiments, a new Transform Domain based Intra (TDI) prediction mode is proposed. In this TDI prediction mode, a current block is predicted based on transform coefficients of a causal neighborhood of the current block. The causal neighborhood of the current block of size N×M is constituted of reconstructed samples in a L-shaped area having height 2N and width 2M. FIG. 7 represents the L-shaped causal area according to various embodiments. In the cases where the reference pixels in the L-shaped area are not available because either one or multiple CUs in the area are not available, it can be decided either not to consider the proposed TDI prediction mode, or to fill up the L-shaped area with by repeating available samples or with a DC value.

FIG. 8 illustrates schematically an embodiment of a method for predicting a block according to the transform domain based intra prediction mode.

The method of FIG. 8 is implemented during step 303 by an encoding module implementing the encoding method of FIG. 3. Indeed, the TDI prediction mode is one of the intra prediction modes considered by the encoding module. In that case, the method of FIG. 8 is executed by the processing module 500 of the system 11.

In a step 80, the processing module 500 of the system 11 obtains a current B block of samples of size N×N of a picture.

In a step 81, the processing module 500 transforms an L-shaped causal area of samples neighboring the current block to obtain a first block of transform coefficients. Two examples of L-shaped causal areas are represented in FIG. 7. For ease of understanding, the current block B is a square of samples of size N×N. In an embodiment of step 81, the transform is a DCT. In the picture domain, the DCT is generally implemented in the form of a matrix operation. Let T denote a forward DCT type II matrix of dimension 2N×2N. Matrix operations implementing a DCT are not well adapted to blocks having an irregular shape such as an L-shaped block. One solution to this problem is to insert zeros in the missing quadrant (the bottom right quadrant in the two examples of FIG. 7) and then apply the transforms in the usual manner. But, this results in large high-frequency coefficients whose quantization can cause visible artefacts after inverse transform operation. In addition, the transform operation leads to 2N×2N ((2M×2N) in case of rectangular blocks) coefficients whereas the input L-shaped block has (2N×2N−N×N) samples, giving a redundant over-complete representation. Both these problems can be avoided by replacing the matrix T by a matrix T_{c} derived from T by exploiting a property of the DCT. T_{c} is defined as follows:

T_{c}≡[Tₑᵥₑₙ T_{odd}]

where Tₑᵥₑₙ and Toda denote respectively matrices consisting of the even and odd columns of the DCT transform matrix T. Tₑᵥₑₙ and T_{odd} both have dimension 2N× N, and thus T_{c} has dimension 2N×2N, the same as of transform T. The transform process applied to the L-shaped causal area of the current block B is detailed in relation to FIG. 8.

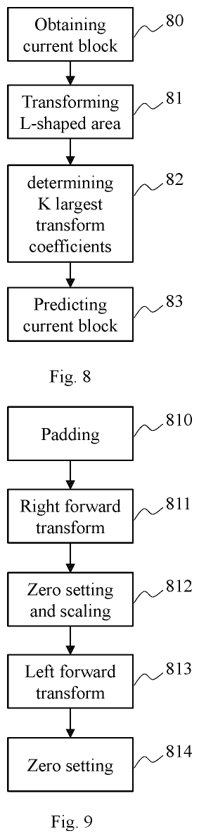

FIG. 9 illustrates a method for applying a DCT transform to an L-shaped causal area neighboring the current block B.

In a step 810, the processing module 500 creates a 2N×2N block B_{2N×2N} from an area comprising the current block and the L-shaped causal area neighboring the current block and replaces the samples values corresponding to the current block by zeros.

In a step 811, the processing module 500 applies a right forward transform to the 2N×2N block B_{2N×2N} by right-multiplying the 2N×2N block B_{2N×2N} by the matrix T_{c} to obtain a right forward transformed block B_{2N×2N}^{RFT} of size 2N×2N:

$${B}_{2 N \times 2 N}^{RFT} = {B}_{2 N \times 2 N} \times {T}_{C}$$

In a step 812, the processing module 500 replaces the coefficients of the right forward transformed block

$${B}_{2 N \times 2 N}^{RFT}$$

corresponding to the current block position with zeros and scale a bottom-left quadrant of the right forward transformed block

$${B}_{2 N \times 2 N}^{RFT}$$

by two. Step 812 allows obtaining an intermediate block

$${B}_{2 N \times 2 N}^{I}$$

of size 2N×2N from the block

$${B}_{2 N \times 2 N}^{RFT} .$$

In a step 813, the processing module 500 applies a left forward transform to the intermediate block

$${B}_{2 N \times 2 N}^{I}$$

by left-multiplying the intermediate block

$${B}_{2 N \times 2 N}^{I}$$

by a matrix

$${T}_{c}^{t}$$

to obtain a left forward transformed block

$${B}_{2 N \times 2 N}^{LFT}$$

of size 2N×2N:

$${B}_{2 N \times 2 N}^{LFT} = {T}_{c}^{t} \times {B}_{2 N \times 2 N}^{I}$$

where the matrix

$${T}_{c}^{t}$$

is the transpose of the matrix T_{c}. The superscript t denote the matrix transpose operation throughout the document.

In a step 814, the processing module 500 replaces the coefficients of the left forward transformed blocks

$${B}_{2 N \times 2 N}^{LFT}$$

at the current block position by zeros to obtain a block

$${B}_{2 N \times 2 N}^{T}$$

corresponding to the result of the transform of the L-shaped causal area neighboring the current block B.

Back to FIG. 8, the block of transform coefficients

$${B}_{2 N \times 2 N}^{T}$$

corresponds to the first block of transform coefficients.

In a step 82, the processing module 500 determines a number of largest transform coefficients K to be kept in the first block of transform coefficients to generate a second block of transform coefficients from which a predictor block is obtained, said predictor block minimizing a difference between the predictor block and the current block. One objective of step 82 is to keep the K first most significant transform coefficients of the first block of transform coefficients

$${B}_{2 N \times 2 N}^{T}$$

in order of decreasing amplitude allowing to obtain the best predictor block B_{pred} for the current block B.

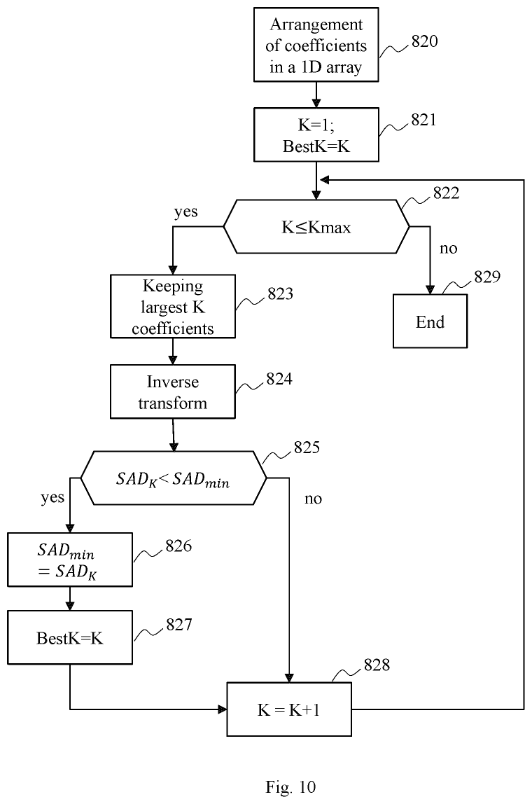

An example of embodiment of step 82 is detailed in relation to FIG. 10.

In a step 820, the processing module 500 arranges the transform coefficients of the first block of transform coefficients

$${B}_{2 N \times 2 N}^{T}$$

in an 1D array m order of decreasing amplitude. Only significant transform coefficients (non-zero transform coefficients) of the first block of transform coefficients

$${B}_{2 N \times 2 N}^{T}$$

are kept in the 1D allay.

In a step 821, the processing module 500 initializes a variable K to “1” and a variable BestK to K.

In a step 822, the processing module 500 determines if the variable K is less than or equal to Kmax. In an embodiment Kmax=2N×2N−N×N=3.N².

If K is less than or equal to Kmax, step 822 is followed by a step 823.

During step 823, the processing module 500 keeps the K largest transform block of transform coefficients

$${B}_{2 N \times 2 N}^{T}$$

and creates the second block of transform coefficients

$${B}_{2 N \times 2 N}^{{T}^{K}}$$

from the kept transform coefficients. To do so, the K largest transform coefficients of the first block of transform coefficients

$${B}_{2 N \times 2 N}^{T}$$

are kept at their positions and the remaining coefficients of the first block of transform coefficients

$${B}_{2 N \times 2 N}^{T}$$

are set to zero.

In a step 824, the processing module 500 inverse transforms the second block of transform coefficients

$${B}_{2 N \times 2 N}^{{T}^{K}} .$$

To do so, the processing module 500 first left multiplies block

$${B}_{2 N \times 2 N}^{{T}^{K}}$$

by the matrix T_{c} and then right multiplies the result by the matrix

$${T}_{c}^{t} .$$

Step 824 allows obtaining block of samples of size

$$2 N \times 2 N {B}_{2 N \times 2 N}^{K} .$$

In a step 825, the processing module 500 extracts a block of samples of size

$$N \times N {B}_{N \times N}^{K}$$

from the right bottom part of block of samples

$${B}_{2 N \times 2 N}^{K} .$$

Then the processing module 500 computes a value representative of a difference between the block of samples

$${B}_{N \times N}^{K}$$

and the current block B. In an embodiment, the value representative of a difference is a Sum of Absolute Difference (SAD) SAD_{K} and compares this SAD SAD_{K} to a value SADₘᵢₙ. If the SAD SAD_{K} is less than SADₘᵢₙ, in a step 826 the processing module 500 sets the value SADₘᵢₙ to the value SAD_{K}. If K=1, the processing module 500 skips step 825 and applies directly step 826.

Step 826 is followed by a step 827 wherein the processing module 500 sets a value BestK to the current value of K.

Step 827 is followed by a step 828 wherein the processing module 500 increments the value of K of one unit.

If, at step 825, SAD_{K} is less than SADₘᵢₙ, step 825 is followed directly by step 828.

Step 828 is followed by step 822. If at step 822, K is higher than Kmax. The process ends in a step 829.

As can be seen, during step 82, the processing module 500 determines the number of largest transform coefficients K to be kept in the first block

$${B}_{2 N \times 2 N}^{T} ,$$

performs an inverse transform of the second block

$${B}_{2 N \times 2 N}^{{T}^{K}}$$

corresponding to the kept transform coefficients to obtain the block of samples of size

$$2 N \times 2 N {B}_{2 N \times 2 N}^{K}$$

and derives a predictor block

$${B}_{N \times N}^{K}$$

from the block of samples

$${B}_{2 N \times 2 N}^{K}$$

minimizing a difference between said predictor block

$${B}_{N \times N}^{K}$$

and the current block B.

At the end of the process of FIG. 10, the processing module 500 has determined the number BestK of most significant transform coefficients to keep in the first block of transform coefficients

$${B}_{2 N \times 2 N}^{T}$$

to create a best predictor block B_{pred} for the current block B, the best predictor block B_{pred} corresponding to the block of samples

$${B}_{N \times N}^{K = B e s t K}$$

Back to FIG. 8, step 82 is followed by a step 83. During step 83, the processing module predicts the current block B from the block B_{pred}. The prediction from of the current block B from the block B_{pred} is the result of the applying of the TDI prediction mode.

In an embodiment, the samples of the block B_{pred} are smoothed in order to avoid discontinuities using the PDPC mode mentioned earlier in the present document. Other smoothing methods such as filtering methods are also possible.

As already mentioned in relation to FIG. 3, the result of the TDI mode is compared to all other possible prediction modes for the current block B in step 306. If the TDI mode is the best mode for encoding the current block B in terms of rate/distortion performance, this mode is selected for the current block B. In that case, a first syntax element indicating the use of the TDI mode for the current block B and a second syntax element representing the value BestK are signaled in the video data 311. The first syntax element is for example a flag TDI_flag equal to “1” is the current block is encoded using the TDI prediction mode and equal to “0” otherwise. This flag could be CABAC encoded. The second syntax element is, for example, encoded with a variable length coding scheme.

One can note that in an embodiment, when a sample comprises a luminance component (Y) and two chrominance components (U and V), steps 81 and 82 are applied only to the luminance component and allow determining a predictor block B_{pred} for the luminance component of the current block B. But, during step 83, the value bestK is used to determine a predictor block for the two chrominance components. When the luma and the chroma components have the same resolution (in 4:4:4 format) steps 81, 823 and 824 are applied to the chrominance components of the current block B using the determined value bestK. However, when the chroma components have a lower resolution luma components (for instance in 4:2:0 format), the value bestK is not used directly. For instance in 4:2:0, the chroma components resolution is half of the luma component resolution in width and height. In that case a value bestK_CH is used to determine a predictor block for the two chrominance components, where bestK_CH=max(1, INT (bestK/4)) where max (x,y) takes the maximum value between x and y and INT(x) takes the integer value of x.

In another embodiment, the process of FIG. 8 is applied independently on each component of the current block B and a value of BestK is signaled for each component if the TDI mode is selected for the current block B.

In the following, we illustrate an example of application of the TDI prediction mode to a current block B of size 4×4. The L-shaped causal area consists of a 4×4 block of decoded samples on top of the current block B, a 4×4 block of decoded samples on left of the current block B, and a 4×4 block of decoded samples on top-left of the current block B. The size of a global area including the L-shaped causal area and the current block B is 8×8. In this example, a DCT transform specified in the HEVC standard is used to derive the transform coefficients. The DCT matrix specified in HEVC has integer elements; therefore after each transform operation there is a scaling required to bring down the values within a specified working dynamic range.

The DCT8 matrix Tin HEVC standard is:

$$T = [ \begin{matrix}64 & 89 & 83 & 75 & 64 & 50 & 36 & 18 \\ 64 & 75 & 36 & - 18 & - 64 & - 89 & - 83 & - 50 \\ 64 & 50 & - 36 & - 89 & - 64 & 18 & 83 & 75 \\ 64 & 18 & - 83 & - 50 & 64 & 75 & - 36 & - 89 \\ 64 & - 18 & - 83 & 50 & 64 & - 75 & - 36 & 89 \\ 64 & - 50 & - 36 & 89 & - 64 & - 18 & 83 & - 75 \\ 64 & - 75 & 36 & 18 & - 64 & 89 & - 83 & 50 \\ 64 & - 89 & 83 & - 75 & 64 & - 50 & 36 & - 18\end{matrix} ]$$

Reorganizing the even and odd columns, we get the transform matrix T_{c} as:

$${T}_{c} = [ \begin{matrix}64 & 83 & 64 & 36 & 89 & 75 & 50 & 18 \\ 64 & 36 & - 64 & - 83 & 75 & - 18 & - 89 & - 50 \\ 64 & - 36 & - 64 & 83 & 50 & - 89 & 18 & 75 \\ 64 & - 83 & 64 & - 36 & 18 & - 50 & 75 & - 89 \\ 64 & - 83 & 64 & - 36 & - 18 & 50 & - 75 & 89 \\ 64 & - 36 & - 64 & 83 & - 50 & 89 & - 18 & - 75 \\ 64 & 36 & - 64 & - 83 & - 75 & 18 & 89 & 50 \\ 64 & 83 & 64 & 36 & - 89 & - 75 & - 50 & - 18\end{matrix} ]$$

Applying step 810, the processing module 500 creates the 2N×2N block B_{2N×2N} from the global area comprising the current block B and the L-shaped causal area neighboring the current block B and replaces the samples values corresponding to the current block by zeros.

$${B}_{2 N \times 2 N} = [ \begin{matrix}129 & 130 & 135 & 133 & 134 & 138 & 136 & 136 \\ 130 & 131 & 134 & 136 & 131 & 136 & 129 & 136 \\ 131 & 136 & 129 & 134 & 133 & 135 & 130 & 128 \\ 133 & 131 & 133 & 134 & 132 & 132 & 129 & 135 \\ 137 & 133 & 137 & 136 & 0 & 0 & 0 & 0 \\ 136 & 130 & 134 & 132 & 0 & 0 & 0 & 0 \\ 134 & 131 & 137 & 138 & 0 & 0 & 0 & 0 \\ 129 & 135 & 136 & 132 & 0 & 0 & 0 & 0\end{matrix} ]$$

Applying step 811, the processing module 500 applies a right forward transform to the 2N×2N block B_{2N×2N} using the matrix T_{c} and then scales the result (i.e., >>2, as scale factor=2⁻⁽⁸⁺³⁻⁹⁾=2⁻²) to obtain the right forward transformed block

$${B}_{2 N \times 2 N}^{RFT}$$

below:

$$[ \begin{matrix}17136 & - 105 & - 112 & 127 & - 310 & - 25 & 14 & 10 \\ 17008 & - 111 & 48 & 199 & - 99 & - 140 & - 35 & - 201 \\ 16896 & - 148 & - 64 & - 114 & 109 & 150 & - 104 & - 196 \\ 16944 & - 4 & 144 & 122 & 15 & - 94 & - 28 & - 60 \\ 8688 & - 15 & 48 & 92 & 7867 & - 2778 & 1920 & - 1503 \\ 8512 & 47 & 64 & 119 & 7733 & - 2667 & 1886 & - 1438 \\ 8640 & - 137 & 64 & 89 & 7771 & - 2850 & 1964 & - 1536 \\ 8512 & - 71 & - 160 & - 6 & 7696 & - 2865 & 1696 & - 1494\end{matrix} ]$$

In a step 812, the processing module 500 replaces the coefficients of the right forward transformed block

$${B}_{2 N \times 2 N}^{RFT}$$

corresponding to the current block position with zeros and scales the bottom-left quadrant of the right forward transformed block

$${B}_{2 N \times 2 N}^{RFT}$$

by two to obtain the intermediate block

$${B}_{2 N \times 2 N}^{I}$$

below

$$[ \begin{matrix}17136 & - 105 & - 112 & 127 & - 310 & - 25 & 14 & 10 \\ 17008 & - 111 & 48 & 199 & - 99 & - 140 & - 35 & - 201 \\ 16896 & - 148 & - 64 & - 114 & 109 & 150 & - 104 & - 196 \\ 16944 & - 4 & 144 & 122 & 15 & - 94 & - 28 & - 60 \\ 17376 & - 30 & 96 & 184 & 0 & 0 & 0 & 0 \\ 17024 & 94 & 128 & 238 & 0 & 0 & 0 & 0 \\ 17280 & - 274 & 128 & 178 & 0 & 0 & 0 & 0 \\ 17024 & - 142 & - 320 & - 12 & 0 & 0 & 0 & 0\end{matrix} ]$$

Applying step 813, the processing module 500 applies the left forward transform to the intermediate block B_{2N×2N}^{I} by left-multiplying the intermediate block B_{2N×2N}^{I} by the matrix T_{c}^{t} and scales the result (i.e., >>9, as scale factor=2⁻⁽³⁺⁶⁾=2⁻⁹) to obtain the left forward transformed block

$${B}_{2 N \times 2 N}^{LFT}$$

below.

$$[ \begin{matrix}17086 & - 90 & 6 & 115 & - 36 & - 14 & - 19 & - 56 \\ 0 & - 58 & - 101 & - 13 & - 67 & - 9 & 12 & 11 \\ 34 & 20 & - 54 & - 10 & - 38 & - 16 & 16 & 43 \\ - 71 & 39 & - 65 & - 54 & 11 & 52 & - 8 & 6 \\ - 48 & 8 & 7 & - 9 & - 57 & - 14 & - 14 & - 49 \\ 90 & 39 & 62 & 87 & - 62 & - 16 & 24 & 48 \\ - 10 & - 29 & 35 & - 12 & - 7 & 13 & 0 & 20 \\ 87 & - 55 & - 21 & - 38 & 12 & 51 & - 6 & 2\end{matrix} ]$$

Applying step 814, the processing module 500 replaces the coefficients of the left forward transformed blocks

$${B}_{2 N \times 2 N}^{LFT}$$

at the current block B position by zeros to obtain a block

$${B}_{2 N \times 2 N}^{T}$$

below corresponding to the result of the transform of the L-shaped causal area neighboring the current block B.

$$[ \begin{matrix}17086 & - 90 & 6 & 115 & - 36 & - 14 & - 19 & - 56 \\ 0 & - 58 & - 101 & - 13 & - 67 & - 9 & 12 & 11 \\ 34 & 20 & - 54 & - 10 & - 38 & - 16 & 16 & 43 \\ - 71 & 39 & - 65 & - 54 & 11 & 52 & - 8 & 6 \\ - 48 & 8 & 7 & - 9 & 0 & 0 & 0 & 0 \\ 90 & 39 & 62 & 87 & 0 & 0 & 0 & 0 \\ - 10 & - 29 & 35 & - 12 & 0 & 0 & 0 & 0 \\ 87 & - 55 & - 21 & - 38 & 0 & 0 & 0 & 0\end{matrix} ]$$

Applying step 820, the processing module 500 arranges the transform coefficients of the first block of transform coefficients

$${B}_{2 N \times 2 N}^{T}$$

in an 1D array in order of decreasing amplitude as below {17086, 115, −101, 90, −90, 87, 87, −71, −67, −65, 62, −58, −56, −55, −54, −54,52, −48,43,39,39, −38, −38, −36,35, 34, −29, −21, 20, −19, −16, 16, −14, −13, −12,12, 11, 11, −10, −10, −9, −9, 8, −8, 7, 6, 6}

Assuming that all the coefficients of the 1D array are kept, the inverse transform step 824 is as follows:

In a step 824, the processing module 500 first left multiplies block

$${B}_{2 N \times 2 N}^{{T}^{K}}$$

by the matrix T_{c} and scales the result (i.e., >>7, as scale factor is 2⁻⁷)

$$[ \begin{matrix}8568 & - 52 & - 56 & 64 & - 77 & - 6 & 4 & 2 \\ 8504 & - 56 & 23 & 100 & - 25 & - 35 & - 9 & - 50 \\ 8448 & - 74 & - 32 & - 57 & 27 & 37 & - 26 & - 49 \\ 8472 & - 1 & 72 & 60 & 3 & - 24 & - 7 & - 15 \\ 8688 & - 16 & 48 & 92 & 3 & - 24 & - 7 & - 15 \\ 8512 & 47 & 64 & 119 & 27 & 37 & - 26 & - 49 \\ 8640 & - 137 & 64 & 88 & - 25 & - 35 & - 9 & - 50 \\ 8512 & - 71 & - 160 & - 6 & - 77 & - 6 & 4 & 2\end{matrix} ]$$

Then, the processing module 500 right multiplies the result by the matrix

$${T}_{c}^{t}$$

and scales the result (i.e., >>12, as scale factor is 2⁻⁽²⁰⁻⁸⁾=2⁻¹²) to obtain the block of samples

$${B}_{2 N \times 2 N}^{K} .$$

$$[ \begin{matrix}\begin{matrix}131 & 132 & 136 & 133 \\ 131 & 130 & 135 & 135 \\ 130 & 134 & 131 & 134 \\ 133 & 131 & 133 & 133\end{matrix} & \begin{matrix}134 & 137 & 134 & 134 \\ 132 & 136 & 129 & 134 \\ 133 & 133 & 132 & 129 \\ 132 & 132 & 130 & 135\end{matrix} \\ \begin{matrix}136 & 133 & 137 & 137 \\ 137 & 131 & 133 & 132 \\ 132 & 132 & 136 & 139 \\ 127 & 134 & 135 & 132\end{matrix} & \begin{matrix}136 & 137 & 132 & 138 \\ 132 & 135 & 129 & 135 \\ 137 & 137 & 131 & 136 \\ 132 & 137 & 136 & 131\end{matrix}\end{matrix} ]$$

The predictor block B_{pred} is shown inside the dashed box above. Similarly, keeping only the most significant transform coefficient (BestK=1) in the first block of transform coefficients

$${B}_{2 N \times 2 N}^{T} ,$$

and applying the inverse transforms, the block of samples

$${B}_{2 N \times 2 N}^{K}$$

is as follows:

$$[ \begin{matrix}\begin{matrix}133 & 133 & 133 & 133 \\ 133 & 133 & 133 & 133 \\ 133 & 133 & 133 & 133 \\ 133 & 133 & 133 & 133\end{matrix} & \begin{matrix}133 & 133 & 133 & 133 \\ 133 & 133 & 133 & 133 \\ 133 & 133 & 133 & 133 \\ 133 & 133 & 133 & 133\end{matrix} \\ \begin{matrix}133 & 133 & 133 & 133 \\ 133 & 133 & 133 & 133 \\ 133 & 133 & 133 & 133 \\ 133 & 133 & 133 & 133\end{matrix} & \begin{matrix}133 & 133 & 133 & 133 \\ 133 & 133 & 133 & 133 \\ 133 & 133 & 133 & 133 \\ 133 & 133 & 133 & 133\end{matrix}\end{matrix} ]$$

In the similar manner, using only the two (BestK=2) and three (BestK=3) most significant transform coefficients in the first block of transform coefficients

$${B}_{2 N \times 2 N}^{T} ,$$

and applying the inverse transforms, the block of samples

$${B}_{2 N \times 2 N}^{K}$$

are respectively as follows:

$$[ \begin{matrix}\begin{matrix}134 & 132 & 135 & 133 \\ 134 & 132 & 135 & 133 \\ 134 & 132 & 135 & 133 \\ 134 & 132 & 135 & 133\end{matrix} & \begin{matrix}133 & 135 & 132 & 134 \\ 133 & 135 & 132 & 134 \\ 133 & 135 & 132 & 134 \\ 133 & 135 & 132 & 134\end{matrix} \\ \begin{matrix}134 & 132 & 135 & 133 \\ 134 & 132 & 135 & 133 \\ 134 & 132 & 135 & 133 \\ 134 & 132 & 135 & 133\end{matrix} & \begin{matrix}133 & 135 & 132 & 134 \\ 133 & 135 & 132 & 134 \\ 133 & 135 & 132 & 134 \\ 133 & 135 & 132 & 134\end{matrix}\end{matrix} ]$$

and

$$[ \begin{matrix}\begin{matrix}133 & 133 & 136 & 132 \\ 134 & 133 & 135 & 133 \\ 134 & 132 & 134 & 133 \\ 135 & 131 & 134 & 134\end{matrix} & \begin{matrix}132 & 136 & 133 & 133 \\ 133 & 135 & 133 & 134 \\ 133 & 134 & 132 & 134 \\ 134 & 134 & 131 & 135\end{matrix} \\ \begin{matrix}135 & 131 & 134 & 134 \\ 134 & 132 & 134 & 133 \\ 134 & 133 & 135 & 133 \\ 133 & 133 & 136 & 132\end{matrix} & \begin{matrix}134 & 134 & 131 & 135 \\ 133 & 134 & 132 & 134 \\ 133 & 135 & 133 & 134 \\ 132 & 136 & 133 & 133\end{matrix}\end{matrix} ] .$$

As we see, the predictor block B_{pred} depends on the number of transform coefficients K kept in the first block of transform coefficients

$${B}_{2 N \times 2 N}^{T}$$

before the application of the inverse transform.

One can note that, for a rectangular current block having width M and height N, the right transforms are obtained from DCT matrix of size M×M, and the left transforms are obtained from the DCT matrix of size N×N, after reorganizing their even and odd columns in the likewise manner. The intermediate steps of scaling and zero-setting remain the same.

In addition, the scaling process applied in the above example in steps 811, 813 and 824 is detailed in section 6.2.5 of document “High Efficiency Video Coding (HEVC), algorithms and architectures, Vivienne Sze, Madhukar Budagavi, Gary J. Sullivan”.

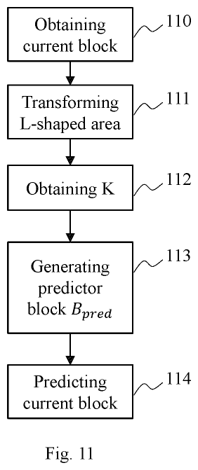

FIG. 11 illustrates schematically an embodiment of a method for reconstructing a block encoded according to the transform domain based intra (TDI) prediction mode.

The method of FIG. 11 is implemented during step 415 by a decoding module implementing the decoding method of FIG. 4. In that case, the method of FIG. 11 is executed by the processing module 500 of the system 13.

In a step 110, the processing module 500 of the system 13 obtains a portion of the video data 311 representing a current block B of samples of size N×N of a picture. It is supposed here that the portion of the video data 311 comprises a syntax element indicating that the current block B was encoded according to the TDI prediction mode.

In a step 111, Since the current block B was encoded according to the TDI prediction mode, the processing module 500 transforms an L-shaped causal area of samples neighboring the current block B to obtain a first block of transform coefficients. To do so, the processing module applies the process described in relation to step 81.

In a step 112, the processing module 500 obtains, from the portion of the video data 311, a syntax element representing the number of largest transform coefficients bestK to be kept in the first block of transform coefficients to generate a second block of transform coefficients from which a predictor block B_{pred} for the current block B is to be obtained.

In a step 113, the processing module 500 generates the predictor block B_{pred} by applying the steps 823 and 824 with K=bestK to obtain a block of samples

$${B}_{2 N \times 2 N}^{K} .$$

Then, the processing module extracts a block of samples of size

$$N \times N {B}_{N \times N}^{K}$$

from the right bottom part of block of samples

$${B}_{2 N \times 2 N}^{K}$$

as in step 823 to obtain the predictor block B_{pred}.

In a step 114, the processing module 500 reconstructs the current block B by predicting it using the predictor block B_{pred}.

In an embodiment of the TDI prediction mode, when the TDI prediction mode is enabled for a current block, intra prediction with sub-partitions (ISP) is disabled, that is, an entire block (i.e., CU) is predicted with the TDI prediction mode. As a reminder, the intra sub-partitions (ISP) mode divides an intra-predicted block vertically or horizontally into “2” or “4” sub-partitions depending on the block size.

In an embodiment of the TDI prediction mode, to keep the complexity required by TDI prediction mode manageable at the encoder, the value of Kmax is kept small, for example, equal to 3 or 4.

In an embodiment of the TDI prediction mode, the value bestK is not signaled. In this case the value of bestK is deduced using any threshold or any other suitable algorithm, or is a fixed value or is systematically equal to the maximum value Kmax, that is, all transform coefficients are used before the inverse transform. The decoder deduces the exact same value of bestK as the encoder by using the same method.

In an embodiment of the TDI prediction mode, the TDI prediction mode and the ISP mode can be enabled together. At least one sub-partition is predicted using TDI prediction mode. When a plurality of sub-partitions is predicted using the TDI prediction mode, the values bestK can be identical or different for each ISP partition predicted using the TDI prediction mode. The values bestK for an ISP partition can be signaled or deduced using any threshold or any other suitable algorithm, or can be a fixed value for example equal to the maximum value Kmax. Again, the decoder deduces the exact same values of bestK for each ISP partition as the encoder by using the same method.

In an embodiment, two or more predictor blocks are constructed using the TDI prediction mode by using two or more values of K before. The obtained predictor blocks are then fused together. In a variant, the fusion is a weighted average of the obtained predictor. For example, the weights used in the weighted average are derived from the amplitude of the transform coefficients kept to construct a predictor block corresponding to a value of K.

In this embodiment of the TDI prediction mode, the TDI prediction mode is enabled only for blocks with a size of the luma component less than a maximum size parameter, namely MAX_CU_SIZE_TDI and/or greater than a minimum size parameter, namely MIN_CU_SIZE_TDI.

In an embodiment of the TDI prediction mode, if a luma component of a current block is predicted with the TDI prediction mode, then the corresponding chroma components may not be systematically predicted with the TDI prediction mode but the TDI prediction mode is one prediction mode tested for the chroma component among other possible prediction modes for the chroma component.

Until now, we have considered that the partitioning is the same for luma and chroma components of a CTU. In some case, luma and chroma components of a CTU may be partitioned differently with so called dual CTU partition trees. In that case, in an embodiment, if a luma block is predicted with the TDI prediction mode, then collocated chroma blocks is also predicted with the TDI prediction mode. In another embodiment, if a luma block is predicted with the TDI prediction mode, then collocated chroma blocks may not be systematically predicted with the TDI prediction mode but the TDI prediction mode is one prediction mode tested for the collocated chroma block among other possible prediction modes for the collocated chroma block.

As for luma blocks, in an embodiment, the TDI prediction mode is enabled for chroma blocks only if said chroma blocks satisfies some size constraints.

In an embodiment, a syntax element signaled in a slice header indicates that all blocks in the slice can use the TDI prediction mode. In a variant, the syntax element signaled in a slice header indicates that all blocks in the slice meeting a given constraint can use the TDI prediction mode.

In an embodiment, a syntax element signaled in a Picture Parameter Set (PPS) indicates that all blocks in a picture referring to this PPS can use the TDI prediction mode. In a variant, the syntax element signaled in a PPS indicates that all blocks in a picture reference to the PPS meeting a given constraint can use the TDI prediction mode.

In an embodiment, a syntax element signaled in a Sequence Parameter Set (SPS) indicates that all blocks in a picture referring to this SPS can use the TDI prediction mode. In a variant, the syntax element signaled in a SPS indicates that all blocks in a picture reference to the SPS meeting a given constraint can use the TDI prediction mode.

In an embodiment, the L-shaped causal area is filtered before being transformed in step 81 and 111. For example, the L-shaped causal area is low pass filtered. In a variant of this embodiment, the predictor block B_{pred} obtained by applying the method of FIG. 8 is in competition with at least one predictor block

$${B}_{pred}^{F}$$

obtained by applying the method of FIG. 8 but wherein the L-shaped causal area is filtered before being transformed in step 81. Several filters could be tested in a set of predefined filters. The predictor block minimizing the rate/distortion trade off is selected. When a predictor block

$${B}_{pred}^{F}$$

is selected, the corresponding filter is signaled. In a variant, when a predictor block B_{pred}^{F} is selected, the corresponding filter is inferred from information available when processing the current block.

In an embodiment, the BestK transform coefficients of the first block of transform coefficients selected in step 82 are not necessarily the BestK first largest transform coefficients of the first block of transform coefficients in order of decreasing amplitude, but a selection of BestK transform coefficients in the first largest transform coefficients of the first block of transform coefficients in order of decreasing amplitude. The selected BestK transform coefficients can be signaled, inferred from information available when processing the current block or fixed and known by the encoder and the decoder.

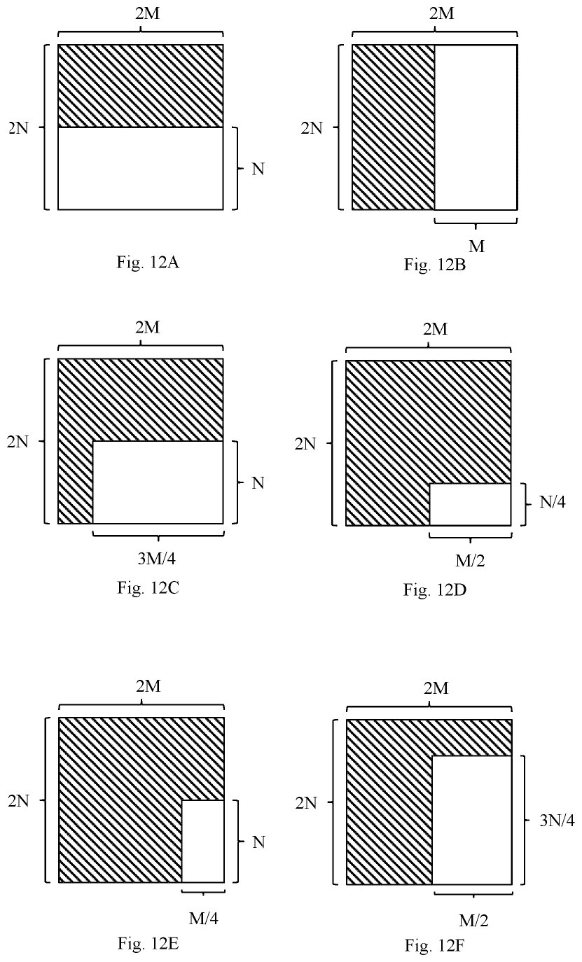

Until now, it is considered that the causal area neighboring the current block B is L-shaped. However, other shapes of the causal area are also possible. FIG. 12A to 12F provide examples of shapes that can be taken as a causal area. In each figure, the current block is represented in white and the causal area is represented by hatched lines. For instance, in FIG. 12A, the current block B is a square or rectangular block of size 2M×N and the causal area is a square or rectangular block of size 2M×N above the current block B. IN FIG. 12C, the current block B is a square or rectangular block of size (3M/4)×N and the causal area is a complementary L-shaped area in a 2M×2N block.

Note that, in case of the causal area of FIG. 12A (respectively 12B), the left (respectively the top) boundary of the current block B is not neighboring the causal area. In an embodiment, external samples at the left (respectively the top) boundary, if available, are used to smooth the samples of the predictor B_{pred} using the PDPC method mentioned earlier in the present document.

We described above a number of embodiments. Features of these embodiments can be provided alone or in any combination. Further, embodiments can include one or more of the following features, devices, or aspects, alone or in any combination, across various claim categories and types:
A bitstream or signal that includes one or more of the described syntax elements, or variations thereof.
Creating and/or transmitting and/or receiving and/or decoding a bitstream or signal that includes one or more of the described syntax elements, or variations thereof.
A TV, set-top box, cell phone, tablet, or other electronic device that performs at least one of the embodiments described.
A TV, set-top box, cell phone, tablet, or other electronic device that performs at least one of the embodiments described, and that displays (e.g. using a monitor, screen, or other type of display) a resulting picture.
A TV, set-top box, cell phone, tablet, or other electronic device that tunes (e.g. using a tuner) a channel to receive a signal including an encoded video stream, and performs at least one of the embodiments described.
A TV, set-top box, cell phone, tablet, or other electronic device that receives (e.g. using an antenna) a signal over the air that includes an encoded video stream, and performs at least one of the embodiments described.
A server, camera, cell phone, tablet or other electronic device that transmits (e.g. using an antenna) a signal over the air that includes an encoded video stream, and performs at least one of the embodiments described.
A server, camera, cell phone, tablet or other electronic device that tunes (e.g. using a tuner) a channel to transmit a signal including an encoded video stream, and performs at least one of the embodiments described.

1. (canceled)

2. A method for decoding comprising:
obtaining video data representing a current block of samples of a picture;
transforming a causal area of samples neighboring the current block to obtain a first block of transform coefficients;
obtaining an information representing a number of largest transform coefficients to be kept in the first block of transform coefficients and performing an inverse transform of a second block corresponding to the kept transform coefficients to obtain a third block;
deriving a predictor block from the third block; and,
reconstructing the current block by predicting the current block using the predictor block.

3. The method of claim 2, wherein the causal area of samples is L-shaped.

4. The method of claim 2, wherein the transform and the inverse transform use a DCT matrix adapted to a shape of the causal area of samples.

5. The method of claim 2, wherein the third block comprises a first sub-part with sample positions corresponding to samples positions of samples of the causal area and a second sub-part with sample positions corresponding to sample positions of samples of the current block and the predictor block corresponds to the second sub-part of the third block.

6. The method of claim 2, wherein the second block of transform coefficients is generated by keeping in the first block of transform coefficients the largest transform coefficients covered by the number of largest transform coefficients of the first block of transform coefficients and by setting to zero the other transform coefficients of the first block of transform coefficients.

7. The method of claim 2, wherein samples of the predictor block are smoothed before prediction.

8. The method of claim 2, wherein the number of largest transform coefficients to be kept in the first block of transform coefficients is less than a maximum value.

9. The method of claim 2, wherein the number of largest transform coefficients to be kept in the first block of transform coefficients is a signaled value in a range of values or is a value derived in a range of values from information available when processing the current block or is a fixed value or is equal to a maximum value.

10. A method comprising disabling an intra sub-partitions mode dividing an intra-predicted block vertically or horizontally in sub-partitions for a current block when the method decoding according to claim 2 is enabled for the current block.

11. A method comprising enabling an intra sub-partitions mode dividing an intra-predicted block vertically or horizontally in sub-partitions for a current block when the method for decoding according to claim 2 is enabled for the current block, and applying the method for decoding according to claim 2 to at least one sub-partition of the current block.

12. A method comprising enabling the method for decoding according to claim 2 for blocks with size less than a maximum size or greater than a minimum size or less than a maximum size and greater than a minimum size.

13. A method wherein an information signaled in a header, the header being a slice header or a picture parameter set or a sequence parameter set, indicates that all blocks of a coding entity referring to the header or all blocks of a coding entity referring to the header and meeting a constraint can use the method for decoding according to claim 2.

14. A device for encoding comprising electronic circuitry configured for:
obtaining a current block of samples of a picture;
transforming a causal area of samples neighboring the current block to obtain a first block of transform coefficients;
obtaining a number of largest transform coefficients to be kept in the first block and performing an inverse transform of a second block corresponding to the kept transform coefficients to obtain a third block;
deriving a predictor block from the third block minimizing a difference between the predictor block and the current block; and,
predicting the current block using the predictor block corresponding to the obtained number of largest transform coefficients.

15. A device for decoding comprising electronic circuitry configured for:
obtaining video data representing a current block of samples of a picture;
transforming a causal area of samples neighboring the current block to obtain a first block of transform coefficients;
obtaining an information representing a number of largest transform coefficients to be kept in the first block of transform coefficients and performing an inverse transform of a second block corresponding to the kept transform coefficients to obtain a third block;
deriving a predictor block from the third block; and,
reconstructing the current block by predicting the current block using the predictor block.

16-29. (canceled)

30. A method for encoding comprising:
obtaining a current block of samples of a picture;
transforming a causal area of samples neighboring the current block to obtain a first block of transform coefficients;
obtaining a number of largest transform coefficients to be kept in the first block and performing an inverse transform of a second block corresponding to the kept transform coefficients to obtain a third block;
deriving a predictor block from the third block minimizing a difference between the predictor block and the current block; and,
predicting the current block using the predictor block corresponding to the obtained number of largest transform coefficients.

31. The method of claim 30, wherein the causal area of samples is L-shaped.

32. The method of claim 30, wherein the transform and the inverse transform use a DCT matrix adapted to a shape of the causal area of samples.

33. The method of claim 30, wherein the third block comprises a first sub-part with sample positions corresponding to samples positions of samples of the causal area and a second sub-part with sample positions corresponding to sample positions of samples of the current block and the predictor block corresponds to the second sub-part of the third block.

34. The method of claim 30, wherein the second block of transform coefficients is generated by keeping in the first block of transform coefficients the largest transform coefficients covered by the number of largest transform coefficients of the first block of transform coefficients and by setting to zero the other transform coefficients of the first block of transform coefficients.

35. The method of claim 30, wherein samples of the predictor block are smoothed before prediction.
